(19) United States
(12) Patent Application Publication
(10) Pub. No.: US 2024/0365745 A1
(43) Pub. Date: Nov. 7, 2024

(54) Cantilevered Animal Bed

(71) Applicant: Omega Paw Inc., St. Marys (CA)

(72) Inventor: Michael Adrian Ebert, St. Marys (CA)

(21) Appl. No.: 18/143,207

(22) Filed: May 4, 2023

(51) Int. Cl. A01K 1/035

(52) U.S. Cl. CPC A01K 1/035

(57) ABSTRACT

A cantilevered animal bed comprises a spanning section and two opposed cantilever supports extending substantially parallel to one another along opposed sides of the spanning section. The cantilever supports are hingedly coupled to the spanning section and are adapted to form load-bearing platforms extending beyond the spanning section. The cantilevered animal bed can be used in conjunction with cushioned furniture. When the spanning section is placed atop a furniture crest (an elongate region of local maximum elevation) with the cantilever supports extending substantially parallel to a longitudinal extent thereof, the cantilevered animal bed conforms to the furniture crest at least by hinged movement of the cantilever supports relative to the spanning section, whereby the furniture crest is disposed between the cantilever supports and the cantilever supports rest against the furniture crest. An embodiment in which one cantilever support is replaced by an anchor is also described.

### TECHNICAL FIELD

The present disclosure relates to animal beds, and more particularly to animal beds adapted to rest atop furniture.

### BACKGROUND

It is not without reason that it has been said that “dogs have masters but cats have staff.” Cats, knowing their position in the universe, often like to rest in elevated positions from which they can suitably survey their subjects. Favorite locations include the higher parts of cushioned furniture, and cats can often be found climbing on the top of a sofa back or padded armchair looking for a place to recline.

Frequently, however, these perches are too narrow to accommodate a cat safely, and the nostrum that cats always land on their feet does not provide any real protection from a dangerous fall, particularly if the cat slips while dozing. Cats are beloved companion animals cherished by their owners, who do their utmost to protect them from harm.

It is therefore desirable to provide an accommodation that allows cats to rest in elevated locations with increased comfort and safety.

### SUMMARY

In one aspect, a cantilevered animal bed comprises a spanning section and two opposed cantilever supports extending substantially parallel to one another along opposed first sides of the spanning section. The cantilever supports are hingedly coupled to the spanning section, and are adapted to form load-bearing platforms extending beyond the spanning section.

A combination comprises the cantilevered animal bed and a piece of cushioned furniture having at least one furniture crest. Each such furniture crest is an elongate region of local maximum elevation on the piece of cushioned furniture. When the spanning section is placed atop (one of) the furniture crest(s) with the cantilever supports extending substantially parallel to a longitudinal extent of the furniture crest, the cantilevered animal bed conforms to that furniture crest at least by hinged movement of the cantilever supports relative to the spanning section, whereby that furniture crest is disposed between the cantilever supports and the cantilever supports rest against that furniture crest.

In some embodiments, the cantilever supports are support bolsters.

The cantilevered animal bed may further comprise comfort bolsters extending along opposed second sides of the spanning section.

The spanning section may be conformable to an underlying surface. In particular embodiments, the spanning section comprises a flexible conforming textile.

The spanning section may be substantially rigid. In particular embodiments where the spanning section is substantially rigid, the cantilever supports are also substantially rigid.

In some embodiments, bodies of the cantilever supports are substantially cylindrical.

In some embodiments, the animal bed is formed as a conformable lemniscate of Bernoulli and the cantilever supports are disposed within leaves of the lemniscate of Bernoulli, whereby the spanning section is formed by a portion of the lemniscate of Bernoulli extending between the cantilever supports.

In some embodiments, a frictional anchoring surface is disposed on at least one of an underside of the spanning section or undersides of the cantilever supports. The frictional anchoring may be releasable from and remountable to the cantilevered animal bed.

In some embodiments, the cantilever supports are hingedly coupled to the spanning section by living hinges.

In some embodiments, the cantilever supports are substantially rigid.

In another aspect, a cantilevered animal bed comprises a spanning section and a cantilever support extending along one of a pair of opposed first sides of the spanning section. The cantilever support is hingedly coupled to the spanning section, and is adapted to form a load-bearing platform extending beyond the spanning section. The cantilevered animal bed further comprises an anchor depending from the spanning section.

In some embodiments, the anchor comprises at least one substantially rigid, planar element.

In some embodiments, the spanning section is substantially rigid.

In some embodiments, the anchor depends from the other of the pair of opposed first sides of the spanning section.

### BRIEF DESCRIPTION OF THE DRAWINGS

These and other features will become more apparent from the following description in which reference is made to the appended drawings wherein:

FIG. 1 is a perspective view of a first non-limiting illustrative embodiment of a cantilevered animal bed according to an aspect of the present disclosure;

FIG. 2 is a perspective view of the cantilevered animal bed of FIG. 1 disposed on the back of a sofa-style couch;

FIG. 3 is an end cross-sectional view of the cantilevered animal bed of FIG. 1;

FIG. 3A is an end cross-sectional view of an embodiment of the first cantilevered animal bed in which silicone dots are disposed on an underside thereof;

FIG. 4 is an end elevation view of the cantilevered animal bed of FIG. 1;

FIG. 5 is a side elevation view of the cantilevered animal bed of FIG. 1;

FIG. 6 is a top plan view of the cantilevered animal bed of FIG. 1;

FIG. 7 shows the cantilevered animal bed of FIG. 1 positioned atop a soft-topped cushion couch;

FIG. 8 shows the cantilevered animal bed of FIG. 1 positioned atop a back of a hard-topped couch;

FIG. 9 shows the cantilevered animal bed of FIG. 1 positioned atop the back of the hard-topped couch of FIG. 8 with the hard-topped couch positioned against a wall;

FIG. 10 is a perspective view showing the cantilevered animal bed of FIG. 1 disposed on the back of the sofa-style couch of FIG. 2 with a cat named “Pepper” resting on the cantilevered animal bed;

FIG. 11 is a perspective view of a second non-limiting illustrative embodiment of a cantilevered animal bed according to an aspect of the present disclosure;

FIG. 12 is an end cross-sectional view of the cantilevered animal bed of FIG. 11;

FIG. 12A is an end cross-sectional view of an embodiment of the second cantilevered animal bed in which silicone dots are disposed on an underside thereof;

FIG. 13 is a side cross-sectional view of the cantilevered animal bed of FIG. 11;

FIG. 13A is a side cross-sectional view of an embodiment of the second cantilevered animal bed in which silicone dots are disposed on an underside thereof;

FIG. 14 is a top plan view of the cantilevered animal bed of FIG. 11;

FIG. 15 shows a third non-limiting illustrative embodiment of a cantilevered animal bed according to an aspect of the present disclosure atop the back of the hard-topped couch of FIG. 8;

FIG. 16 shows the cantilevered animal bed of FIG. 15 positioned atop an armrest of the hard-topped couch of FIG. 8;

FIG. 17 is a perspective view showing the cantilevered animal bed of FIG. 1 disposed on an armrest of the sofa-style couch of FIG. 2 with a cat named “Cooper” resting on the cantilevered animal bed;

FIG. 18A is a side elevation view showing a fourth non-limiting illustrative embodiment of a cantilevered animal bed disposed atop a narrower furniture crest that is flat-topped with rounded edges;

FIG. 18B is a side elevation view showing the fourth cantilevered animal bed disposed atop a wider furniture crest that is flat-topped with rounded edges;

FIG. 18C is a side elevation view showing the fourth cantilevered animal bed disposed atop a narrower rounded furniture crest;

FIG. 18D is a side elevation view showing the fourth cantilevered animal bed disposed atop a wider rounded furniture crest;

FIG. 19A is a side elevation view showing a fifth non-limiting illustrative embodiment of a cantilevered animal bed disposed atop a narrower furniture crest that is flat-topped with rounded edges;

FIG. 19B is a side elevation view showing the fifth cantilevered animal bed disposed atop a narrower rounded furniture crest;

FIG. 20 is a perspective view showing the fourth cantilevered animal bed disposed atop the narrower flat-topped furniture crest of FIG. 18A;

FIG. 21 is an end view of the armrest shown in FIG. 17, depicting Cooper the cat resting on the cantilevered animal bed in a slightly different position than in FIG. 17;

FIG. 22 is a side cross-sectional view showing a sixth non-limiting illustrative embodiment of a cantilevered animal bed;

FIG. 23 is a side cross-sectional view showing a seventh non-limiting illustrative embodiment of a cantilevered animal bed;

FIG. 24 shows the cantilevered animal bed of FIG. 23 atop the back of the hard-topped couch of FIG. 8; and

FIG. 25 shows an eighth non-limiting illustrative embodiment of a cantilevered animal bed atop the back of the hard-topped couch of FIG. 8.

### DETAILED DESCRIPTION

The present disclosure describes a cantilevered animal bed adapted to rest on a furniture crest to provide support for a domestic pet animal. As used herein, the term “furniture crest” refers to an elongate region of local maximum elevation on a piece of furniture, such as a couch or a padded armchair. Thus, the cushioned armrest and the cushioned top of the back of a couch or cushioned chair are examples of furniture crests. While animal beds according to the present disclosure are particularly well-suited to cats, they may also be used with what cats might describe as “lesser” pet animals, such as dogs, among others.

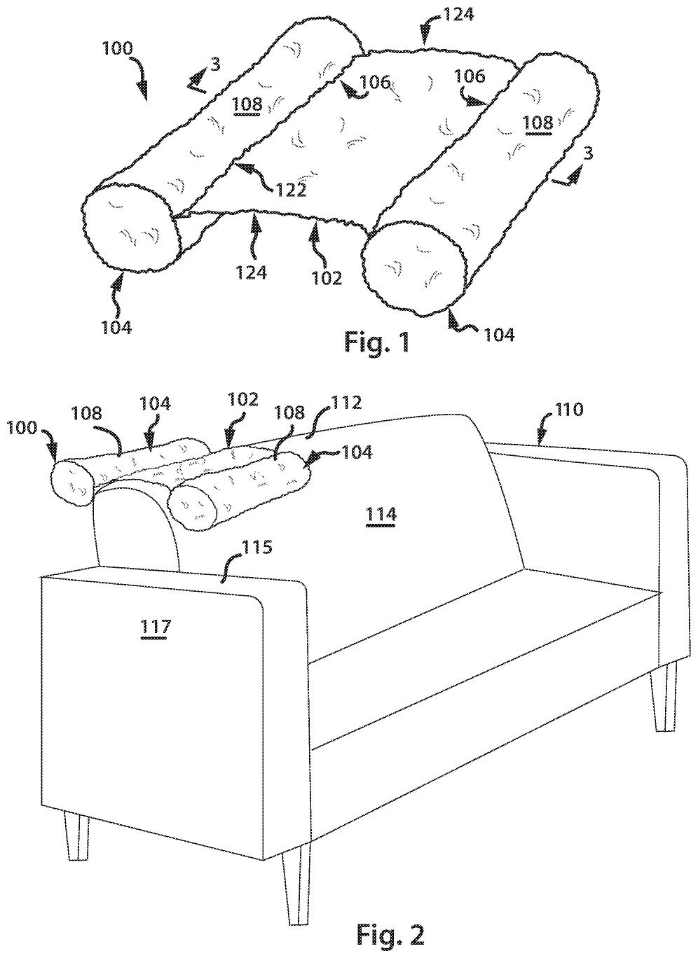

Reference is now made to FIG. 1, which shows a first non-limiting illustrative embodiment of a cantilevered animal bed, indicated generally by reference 100, according to an aspect of the present disclosure. The cantilever bed 100 shown in FIG. 1 comprises a rectangular spanning section 102 and two opposed cantilever supports 104. The cantilever supports 104 extend substantially parallel to one another along opposed first sides 106 of the spanning section 102, and are hingedly coupled to the spanning section 102. The cantilever supports 104 form load-bearing platforms 108 extending beyond the spanning section 102.

In the embodiment shown in FIG. 1, the spanning section 102 is conformable to an underlying surface, and in the illustrated embodiment the spanning section 102 comprises a flexible conforming textile, for example a plush fabric. The spanning section 102 may form an enclosure with padding enclosed therewithin, or may consist of one or more layers of textile or similar material without padding.

Reference is now made to FIG. 2, which shows the cantilevered animal bed 100 from FIG. 1 disposed on the back of a sofa-style couch 110. The sofa-style couch 110 is an example of piece of cushioned furniture, and the top 112 of the back 114 of the sofa-style couch 110 is an example of a furniture crest, as is the top 115 of the armrest 117.

As can be seen in FIG. 2, the spanning section 102 is placed on the top 112 of the back 114 of the sofa-style couch 110 with the cantilever supports 104 extending substantially parallel to the longitudinal extent of the back 114 of the sofa-style couch 110. When so placed, the cantilevered animal bed 100 conforms to the back 114 of the sofa-style couch 110 in two ways. First, the cantilevered animal bed 100 conforms to the back 114 of the sofa-style couch 110 by hinged movement of the cantilever supports 104 relative to the spanning section 102, so that the back 114 of the sofa-style couch 110 is disposed between the cantilever supports 104 and the cantilever supports 104 rest against the back 114 of the sofa-style couch 110. Second, because the spanning section 102 is conformable to an underlying in surface, the spanning section 102 drapes across the top 112 of the back 114 of the sofa-style couch 110.

As can be seen in FIG. 2, the cantilever supports 104 extend horizontally beyond the vertical support provided by the back 114 of the sofa-style couch 110. Because the cantilever supports are braced against respective sides of the back 114 of the sofa-style couch 110, each cantilever support 104 forms a support platform 108 that extends outwardly beyond the top 112 of the back 114 of the sofa-style couch 110.

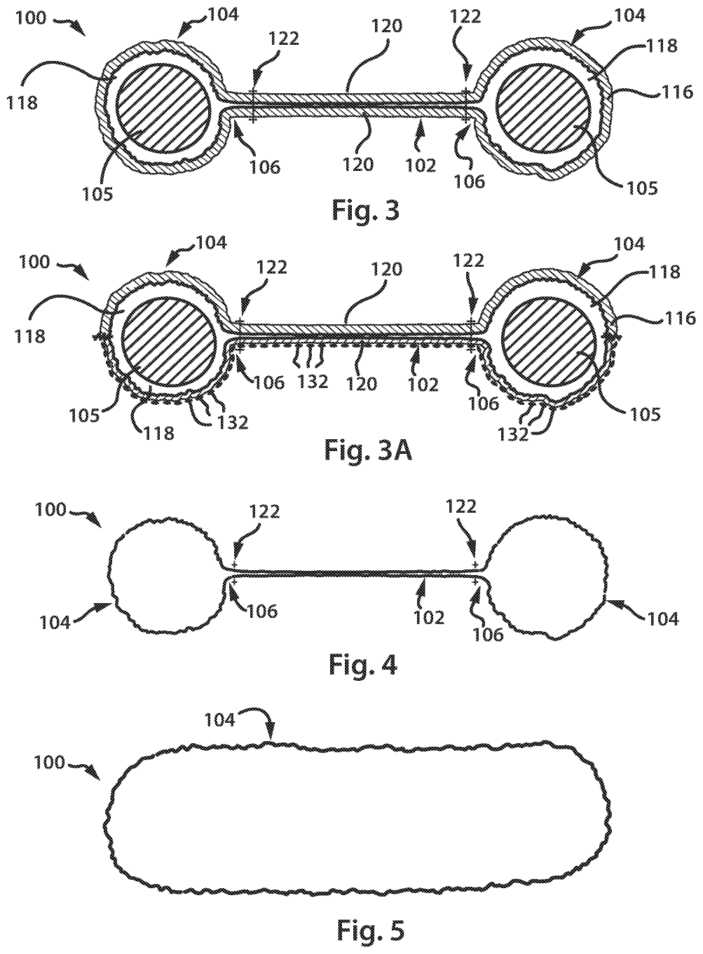

Reference is now made to FIG. 3, which shows a cross-sectional view of the cantilevered animal bed 100 exposing the bodies 105 of the cantilever supports 104. In the illustrated embodiment, the bodies 105 of the cantilever supports 104 are substantially cylindrical; this is merely illustrative and not limiting. For example, and without limitation, in other embodiments the bodies of the cantilever supports may be elongate polygonal prisms, including without limitation hexagonal prisms, octagonal prisms and triangular prisms, although the cylindrical shape is preferred.

The bodies 105 of the cantilever supports 104 are rigid or at least substantially rigid, that is, they may have some limited flexibility but still possess sufficient rigidity to provide the requisite load-bearing support for the weight of the animal with which the cantilevered animal bed 100 is to be used. One non-limiting example of a suitable material for the bodies 105 of the cantilever supports 104 is closed cell polyethylene (PE) foam of the type used to make so-called “pool noodles”; in fact, in some embodiments the bodies 105 of the cantilever supports 104 may be constructed by cutting such pool noodles to a suitable length. Other suitable materials may also be used, including without limitation dense foam, or densely packed stuffing that can provide the requisite load-bearing support for the weight of the animal.

Continuing to refer to FIG. 3, it can be seen that in the illustrated embodiment, the cantilevered animal bed is formed by a textile envelope 116 comprising two substantially closed support sleeves 118 that enclose the bodies 105 of the respective cantilever supports 104. The support sleeves 118 are spaced apart from one another by the spanning section 102. In the illustrated embodiment, the spanning section is formed merely by two opposed textile layers 120 without internal padding; other embodiments may include padding or cushioning between the textile layers and/or may comprise only a single textile layer or more than two textile layers. The textile envelope 116 may be formed from one or more individual textile pieces joined together, for example by stitching.

In this embodiment, the support sleeves 118 are demarcated from the spanning section 102 by a line of support stitching 122 extending substantially parallel to the bodies 105 of the cantilever supports 104 and by which the support sleeves 118 also enclose the bodies 105 of the respective cantilever supports 104. Other configurations are also contemplated, some of which are described further below. Each line of support stitching 122 may also function as a living hinge by which the respective cantilever supports 104 are hingedly coupled to the spanning section 102. Thus, in some embodiments the cantilever supports 104 are hingedly coupled to the spanning section 102 by living hinges.

Preferably, the textile envelope 116 is made from textile(s) that are machine washable, and optionally the support sleeves 118 may be provided with releasable and reclosable closures, such as snap-fasteners or hook-and-loop fasteners, so that the bodies 105 of the cantilever supports 104 can be withdrawn from the support sleeves 118 to facilitate washing. For example and without limitation, one or more machine-washable fluid-resistant layers, optionally coupled with one or more machine-washable absorbent layers, may be disposed between the outer layer(s) of the textile envelope 116 to protect underlying furniture from an incontinent animal. This will allow an aged but still beloved animal to continued using its preferred sleeping spot.

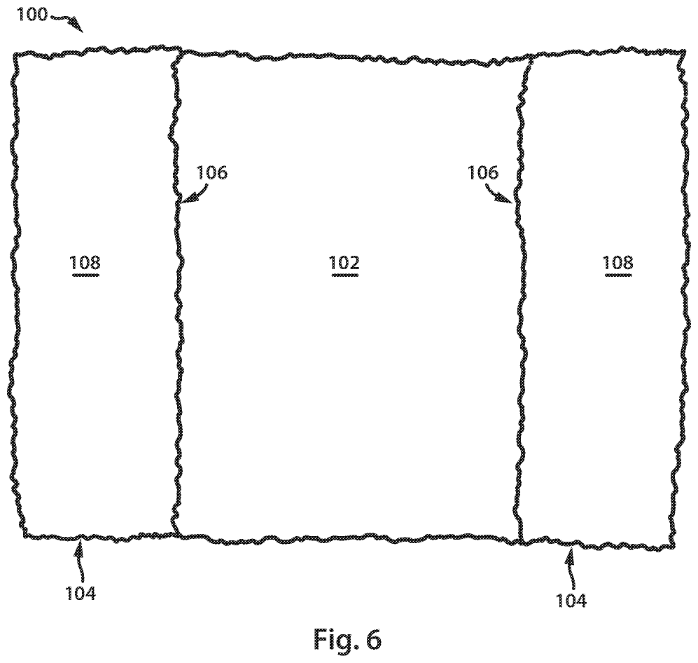

FIG. 4 shows an end view of the cantilevered animal bed 100 comparable to the cross-sectional view shown in FIG. 3, FIG. 5 shows a side elevation view of the cantilevered animal bed 100, and FIG. 6 shows a top view.

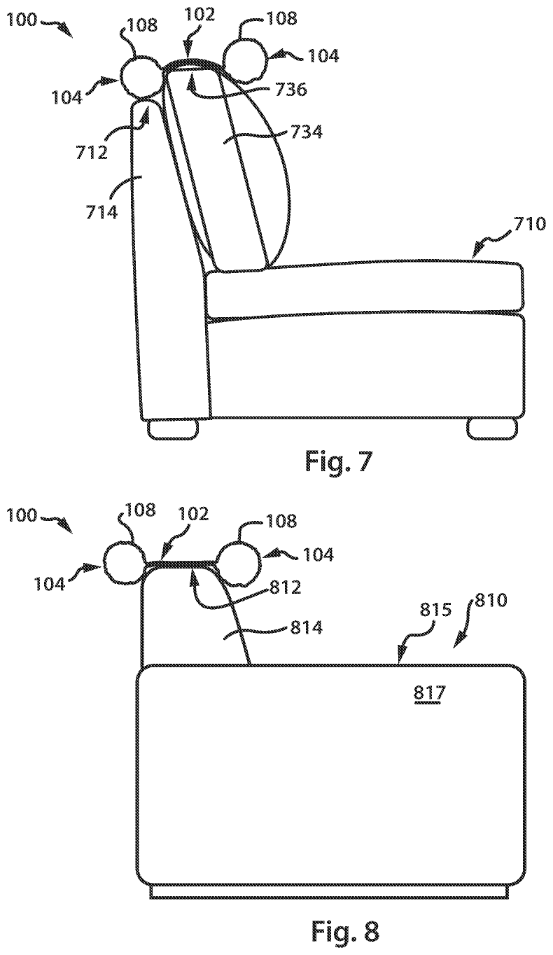

FIGS. 7 to 9 show how the cantilevered animal bed 100 conforms to various types of furniture in various configurations.

FIG. 7 shows the cantilevered animal bed 100 on a soft-topped cushion couch 710, specifically atop one of the back cushions 734. Hinged movement of the cantilever supports 104 relative to the spanning section 102 conforms the cantilevered animal bed 100 to the top 736 of the back cushion 734, so that the back cushion 734 is disposed between the cantilever supports 104 and the cantilever supports 104 rest against the back cushion 734. The cantilever supports 104 extend horizontally beyond the vertical support provided by the back cushion 734, and are braced against respective sides of the back cushion 734 whereby each cantilever support 104 forms a support platform 108 that extends outwardly beyond the top 736 of the back cushion 734. In addition, one of the cantilever supports 104 rests on and is further supported by the top 712 of the back 714 of the soft-topped cushion couch 710. Further, the conformable spanning section 102 drapes across the top 736 of the back cushion 734.

FIG. 8 shows the cantilevered animal bed 100 on a hard-topped couch 810. The back 814 of the hard-topped couch 810 is disposed between the cantilever supports 104 and the cantilever supports 104 rest against either side of the back 814 of the hard-topped couch 810. In this case, because the top 812 of the back 814 of the hard-topped couch 810 is a hard, planar surface, the spanning section 102 simply lays flat, and the cantilever supports 104 extend horizontally beyond the vertical support provided by the back 814 of the hard-topped couch 810. Again, the cantilever supports 104 are braced against respective sides of the back 814 of the hard-topped couch 810 so that each cantilever support 104 forms a support platform 108 extending outwardly beyond the top 812 of the back 814 of the hard-topped couch 810.

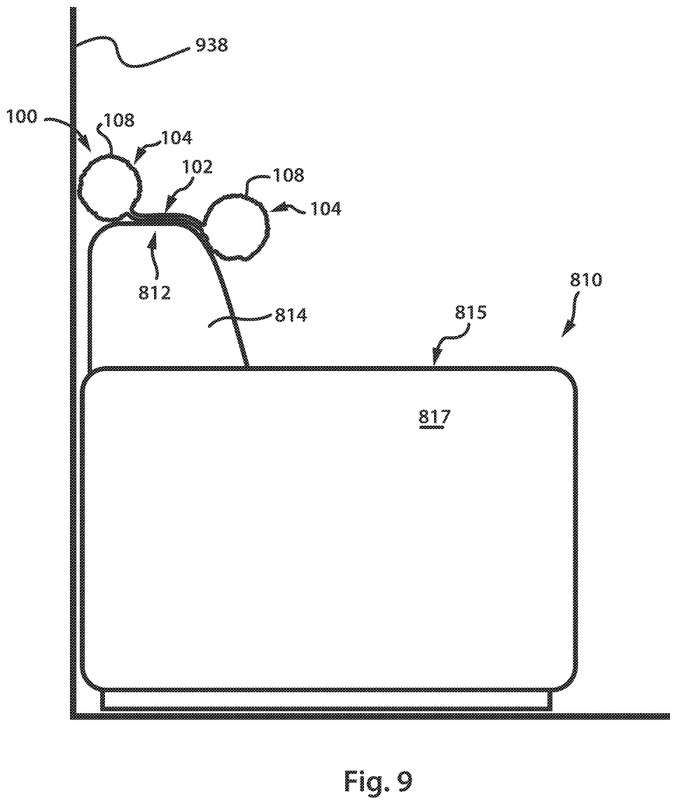

Reference is now made to FIG. 9, which shows an alternate configuration where the back 814 of the hard-topped couch 810 is placed against a wall 938. In this configuration, the cantilevered animal bed 100 conforms to the combined contour formed by the top 812 of the back 814 of the hard-topped couch 810 and the wall 938 against which the hard-topped couch 810 is placed. Hinged movement of the cantilever support 104 closest to the wall 938 allows that cantilever support 104 to pivot upward relative to the spanning section 102 and rest against the wall 938, forming a first support platform 108. The cantilever support 104 furthest from the wall 938 is braced against the back 814 of the hard-topped couch 810 to form a second support platform 108 that extends outwardly beyond the top 812 of the back 814 of the hard-topped couch 810. The spanning section 102 conforms to the edge curvature at the top 812 of the back 814 of the hard-topped couch 810.

Even though the spanning section 102 is itself flexible, the cantilever supports 104 are nonetheless hingedly coupled to the spanning section 102 because they can hinge relative to the spanning section 102 when the spanning section 102 has conformed to an underlying surface as shown in FIGS. 7 to 9. Moreover, the cantilever supports 104 could hinge relative to the spanning section 102 even if the spanning section were rigid (e.g. if a rigid panel were disposed between the textile layers 120 of the spanning section 102); some alternative embodiments described below include a rigid spanning section.

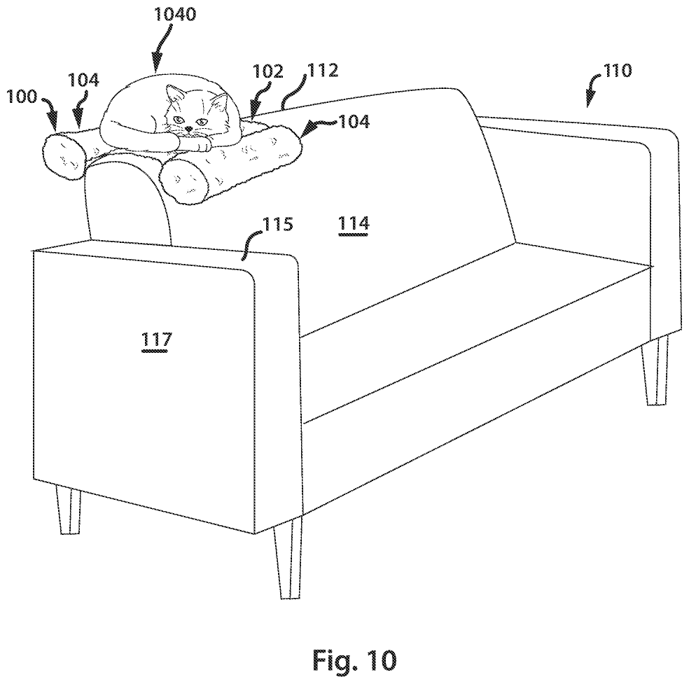

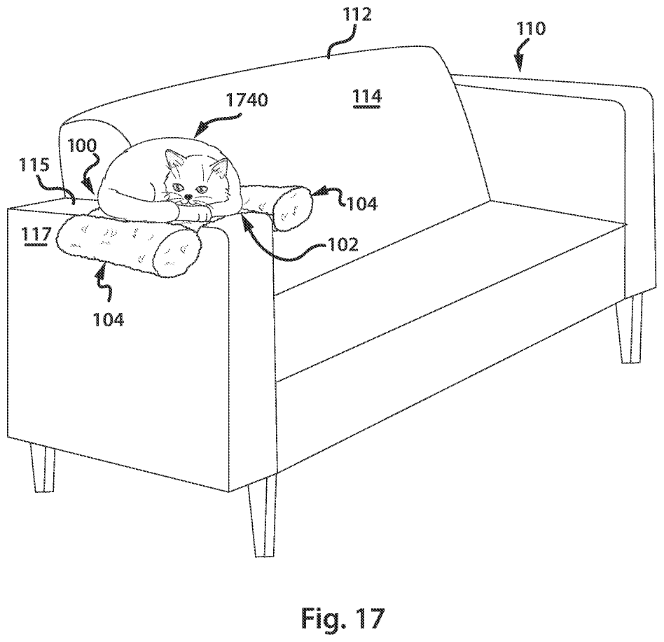

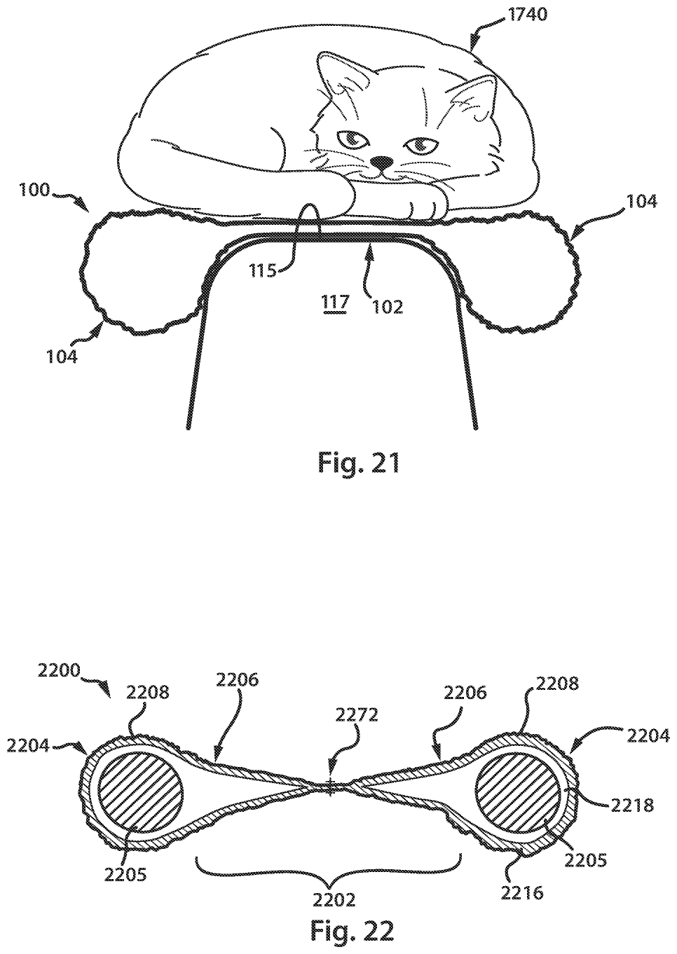

FIG. 10 shows a first exemplary cat 1040, in this case a cat named “Pepper” having a ‘princess’ personality, snoozing comfortably on the cantilevered animal bed 100 with the cantilevered animal bed 100 disposed on the top 112 of the back 114 of the sofa-style couch 110 shown in FIG. 2. FIG. 17 shows a second exemplary cat 1740, in this case the normally rambunctious “Cooper”, resting on the cantilevered animal bed 100 with the cantilevered animal bed 100 disposed on the top 115 of the armrest 117 of the sofa-style couch 110. FIG. 21 is an end view of the armrest 117, showing Cooper 1740 resting on the cantilevered animal bed 100 in a slightly different position than in FIG. 17. FIG. 21 shows how the cantilever supports 104 cooperate with the armrest 117 to support the weight of Cooper 1740 even though his body extends beyond the armrest 117 on either side thereof. “Cooper” and “Pepper” are provided as illustrative examples, and are not limiting; cantilevered animal beds according to the present invention may be used with any suitable domestic animal.

As can be seen in FIGS. 1 to 10, in the illustrated embodiment the cantilever supports 104 are support bolsters; that is, while the cantilever supports 104 form load-bearing platforms 108, by their shape and configuration the cantilever supports 104 also function as elongate pillows on which an animal can rest its head, or perhaps its feet, as the animal may desire. In this regard, padding or cushioning may be disposed between the bodies 105 of the cantilever supports 104 and the support sleeves 118 for increased comfort, given the rigidity of the cantilever supports 104. In alternative embodiments, soft, cushioned bolsters may be disposed upon the cantilever supports.

The illustrative animal bed 100 shown in FIGS. 1 to 10, the support bolsters formed by the cantilever supports 104 extend only along the first sides 106 of the spanning section 102, with no bolsters or pillows along the opposed second sides 124. Other embodiments may include not only support bolsters, but also cushioning bolsters that serve as pillows but which are not adapted to form load-bearing platforms.

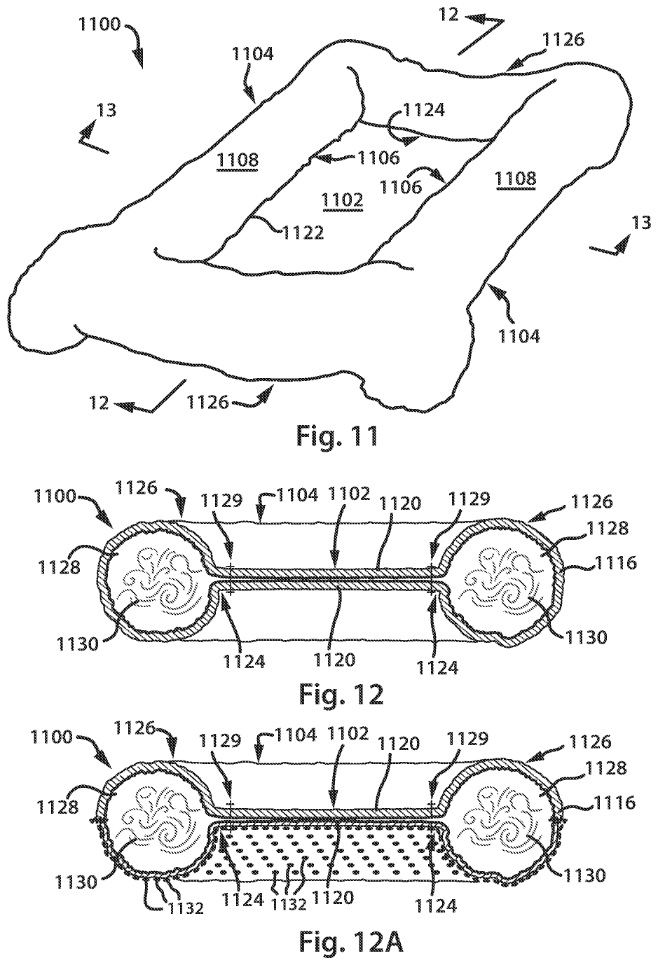

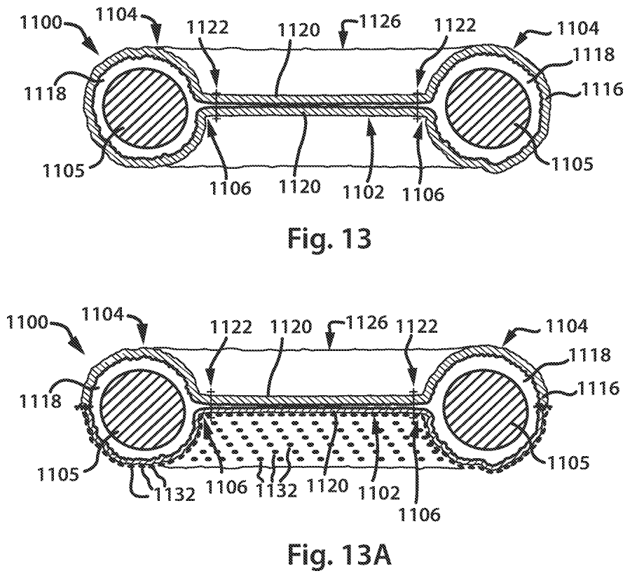

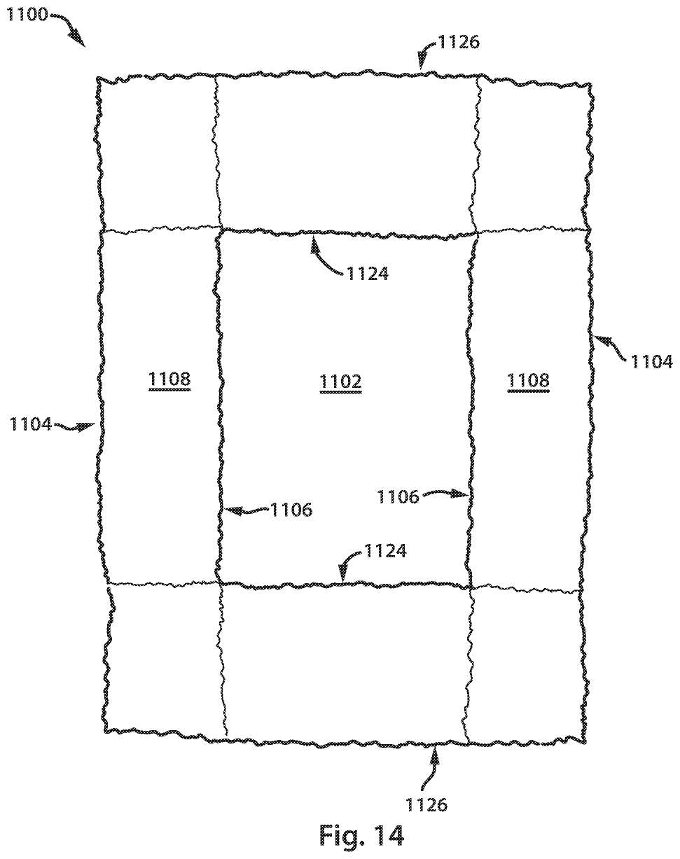

Reference is now made to FIGS. 11 to 14, which show a second non-limiting illustrative embodiment of a cantilevered animal bed, indicated generally by reference 1100, according to an aspect of the present disclosure. The second cantilevered animal bed 1100 shown in FIGS. 11 to 14 is similar to the first cantilevered animal bed 100 shown in FIGS. 1 to 10, with like reference numerals denoting like features, but with the prefix “11” instead of “1”. The second cantilevered animal bed 1100 differs from the first cantilevered animal bed 100 in that in addition to the support bolsters formed by the cantilever supports 104, the second cantilevered animal bed also has comfort bolsters 1126 extending along the opposed second sides 1124 of the spanning section 1102.

As shown in the cross-sectional view in FIG. 12, in the illustrated embodiment the comfort bolsters are formed by enclosed pillow sleeves 1128 spaced apart from one another by the spanning section 1102, with the pillow sleeves 1128 being substantially normal to the support sleeves 1118 (see FIG. 11). The pillow sleeves 1128 are demarcated from the spanning section 1102 by a line of pillow stitching 1129 extending substantially normal to the cantilever supports 1104 and by which the pillow sleeves 1128 enclose padding or cushioning 1130 so that the pillow sleeves 1128 are formed into the comfort bolsters 1126. Of note, the comfort bolsters 1126 are pliant and flexible so as not to inhibit conformation of the spanning section 1102 or hinged movement of the cantilever supports 1104 relative to the spanning section 1102. The padding 1130 may be, by way of example and without limitation, machine-washable polyester fiberfill, foam chips, or memory foam. In the case of memory foam or other cushioning material that is not machine washable, the pillow sleeves 1128 may be provided with releasable and reclosable closures, such as snap-fasteners or hook-and-loop fasteners, so that the cushioning material can be withdrawn from the pillow sleeves 1128 to facilitate washing.

In certain preferred embodiments, cantilevered animal beds according to the present disclosure are provided with a frictional anchoring surface to assist in maintaining the cantilevered animal bed in position on the furniture crest.

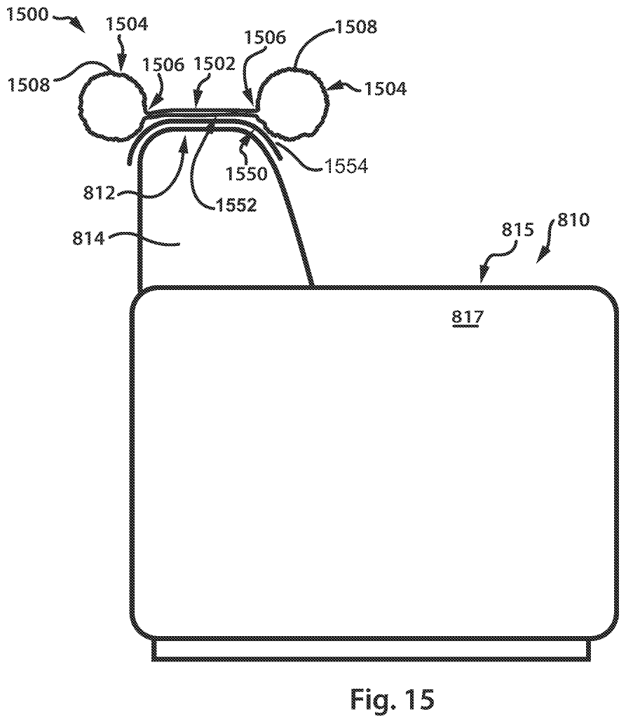

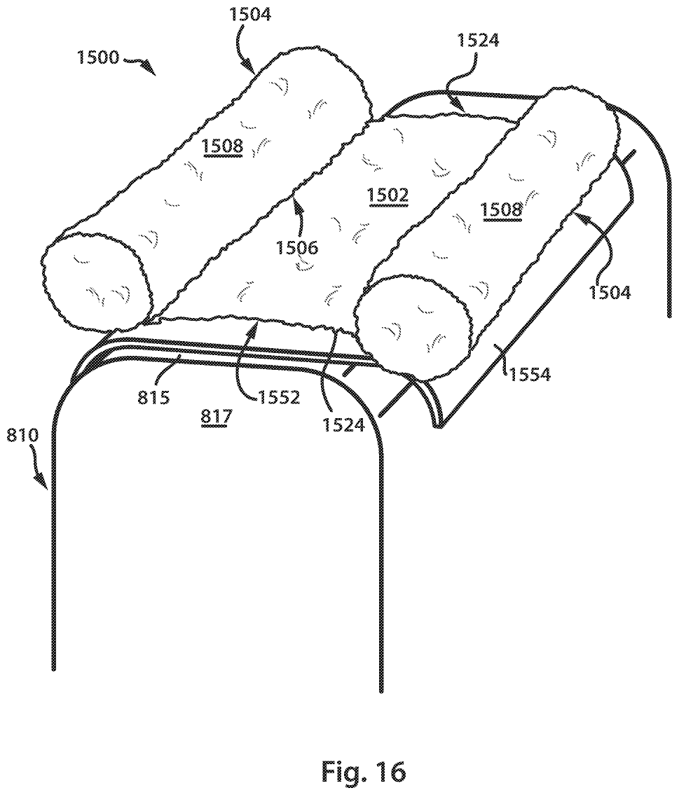

Reference is now made to FIGS. 15 and 16, which show a third non-limiting illustrative embodiment of a cantilevered animal bed, indicated generally by reference 1500, according to an aspect of the present disclosure. The third cantilevered animal bed 1500 shown in FIGS. 15 and 16 is similar to the first cantilevered animal bed 100 shown in FIGS. 1 to 10, with like reference numerals denoting like features, but with the prefix “15” instead of “1”. The third cantilevered animal bed 1500 differs from the first cantilevered 20 animal bed 100 in that the third cantilevered animal bed 1500 is provided with a frictional anchoring surface 1550.

In the illustrated embodiment, the frictional anchoring surface 1550 is disposed on the underside 1552 of the spanning section 1502, and extends beyond the spanning section 1502 to underlie the cantilever supports 1504. As can be seen in FIG. 15, the frictional anchoring surface 1550 conforms to and frictionally engages the top 812 of the back 814 of the hard-topped couch 810 to assist in anchoring the cantilevered animal bed 1500 on the hard-topped couch 810. Similarly, in FIG. 16 the frictional anchoring surface 1550 conforms to and frictionally engages the top 815 of an armrest 817 of the hard-topped couch 810 to assist in anchoring the cantilevered animal bed 1500 on the hard-topped couch 810.

In the embodiment shown, the frictional anchoring surface 1550 is formed by a rubber sheet 1554 that is affixed to both the spanning section 1502 and the cantilever supports 1504; in other embodiments the rubber sheet may be affixed to only the spanning section, or only to one or both of the cantilever supports. The rubber sheet 1554 is preferably removably affixed to the cantilevered animal bed 1500, for example by way of hook-and-loop fasteners or snap fasteners, so that the rubber sheet 1554 may be removed to facilitate washing of the cantilevered animal bed 1500. Thus, in a preferred embodiment the frictional anchoring surface is releasable from and remountable to the cantilevered animal bed 1500. In some embodiments, the rubber sheet may comprise multiple individual rubber strips. Moreover, rubber is merely one non-limiting example of a material that may be used to provide a frictional anchoring surface; other suitable materials may also be used which could include anti-slip fabric (for example, fabric with silicone dots or silicone patterns distributed thereupon) or other non-slip materials. For example, rather than a releasable frictional anchoring surface, the underside of the spanning section and/or the undersides of the cantilever supports may be formed from an anti-slip fabric. FIG. 3A shows, by way of non-limiting example, an embodiment of the first cantilevered animal bed 100 in which silicone dots 132 are disposed on the portions of the textile envelope 116 of the first cantilevered animal bed 100 that will form the underside thereof, on both the support sleeves 118 and the spanning section 102. FIGS. 12A an 13A similarly show, by way of non-limiting example, an embodiment of the second cantilevered animal bed 1100 in which silicone dots 1132 are disposed on the portions of the textile envelope 1116 of the second cantilevered animal bed 1100 that will form the underside thereof, on both the support sleeves 1118 and the pillow sleeves 1128 as well as the spanning section 1102. Further, in other embodiments, the frictional anchoring surface may be disposed only on undersides of the cantilever supports, or only on undersides of the spanning section.

Although only two embodiments incorporating a frictional anchoring surface are described and illustrated in detail, it is to be understood that any cantilevered animal bed constructed according to the principles of the present disclosure may incorporate a frictional anchoring surface.

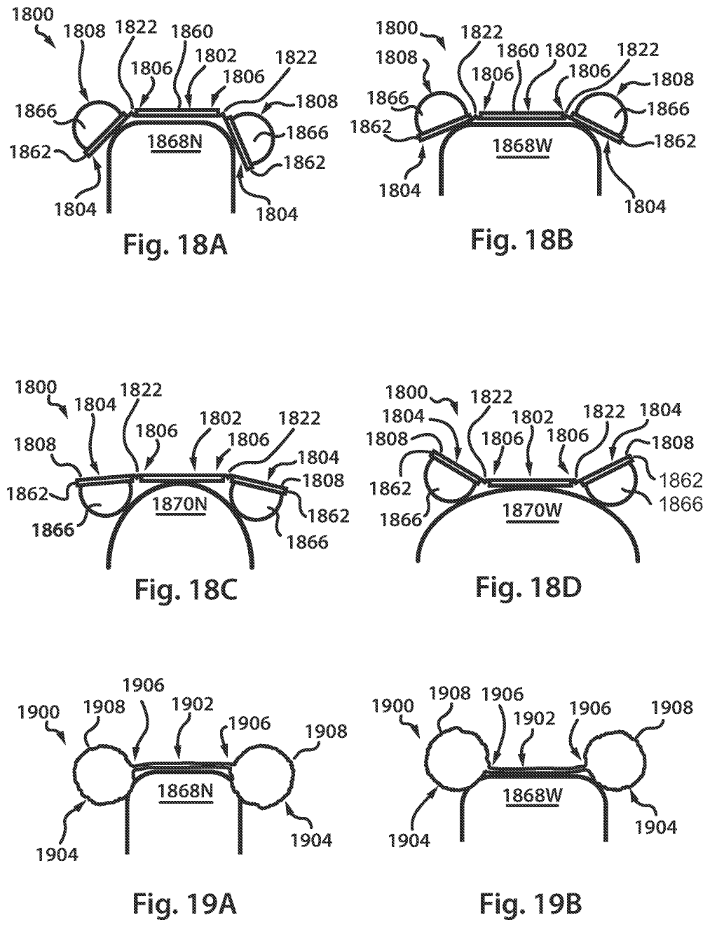

Reference is now made to FIGS. 18A to 20, which show a fourth illustrative non-limiting embodiment of a cantilevered animal bed, indicated generally by reference 1800. The cantilevered animal bed 1800 shown in FIG. 18 comprises a rectangular spanning section 1802 and two opposed cantilever supports 1804. The cantilever supports 1804 extend substantially parallel to one another along opposed first sides 1806 of the spanning section 1802, and are hingedly coupled to the spanning section 1802. In the illustrated embodiment an elongate living hinge 1822 extends between the cantilever supports 1804 and the spanning section 1802; in other embodiments a plurality of individual hinges may be used. The cantilever supports 1804 form load-bearing platforms 1808 extending beyond the spanning section 1802.

In the fourth cantilevered animal bed 1800, both the spanning section 1802 and the cantilever supports 1804 are rigid or at least substantially rigid, and may be formed, for example, by respective generally planar panels 1860, 1862. The panels 1860, 1862 may be formed, for example, from wood, metal or a suitable plastic, and may be covered with fabric for comfort; cushioning may be disposed between the covering fabric and the panels 1860, 1862. Alternatively, the panels may have a slight curvature rather than being planar. In some embodiments, a removable textile envelope, with or without padding may enclose the spanning section and/or the panels.

In the illustrated embodiment, the cantilever supports 1804 comprise bolsters 1866; the bolsters 1866 may also be covered by fabric with underlying cushioning. Preferably, the bolsters 1866 are support bolsters, and may be formed, for example, from closed cell polyethylene (PE) foam of the type used to make so-called “pool noodles”; in fact in some embodiments the cantilever supports 104 may be constructed by cutting such pool noodles into a suitable shape, e.g. a Quonset shape as shown, among others. Other suitable materials may also be used, including without limitation dense foam, or densely packed stuffing that can provide the requisite load-bearing support for the weight of the animal. Alternatively, the bolsters 1866 may be comfort bolsters containing softer padding.

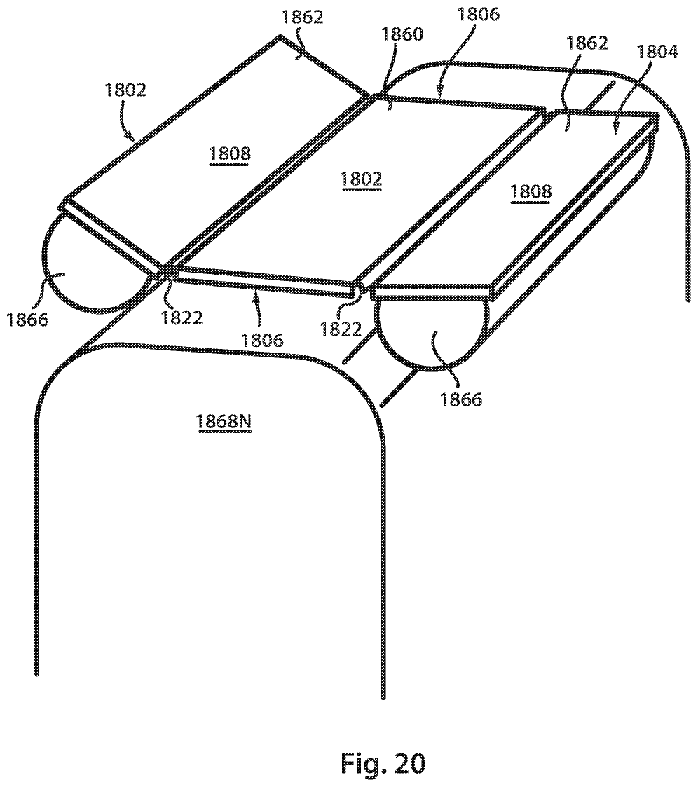

FIGS. 18A and 18B show how the fourth cantilevered animal bed 1800 can be disposed atop a narrower furniture crest 1868N (FIG. 18A) or a wider furniture crest 1868W (FIG. 18B) where the furniture crest 1868N, 1868W is flat-topped with rounded edges. In FIGS. 18A and 18B, the cantilevered animal bed 1800 is positioned with the bolsters 1866 facing away from the furniture crest 1868N, 1868W. FIGS. 18C and 18D show how the fourth cantilevered animal bed 1800 can be disposed atop a narrower rounded furniture crest 1870N (FIG. 18C) or wider rounded furniture crest 1870W (FIG. 18D). In FIGS. 18C and 18D, the cantilevered animal bed 1800 is positioned with the bolsters 1866 facing toward the furniture crest 1870N, 1870W. FIG. 20 shows how the fourth cantilevered animal bed 1800 can be disposed atop a narrower furniture crest 1868N with the bolsters 1866 facing toward the narrower furniture crest 1868N.

FIGS. 19A and 19B show a fifth non-limiting illustrative embodiment of a cantilevered animal bed, indicated generally by reference 1900. The fifth cantilevered animal bed 1900 is similar to the first cantilevered animal bed 100, with like reference numerals denoting like features except with the prefix “19” instead of “1”. The fifth cantilevered animal bed 1900 differs from the first cantilevered animal bed 100 primarily in that the fifth cantilevered animal bed 1900 has a spanning section 1902 that is at least substantially rigid. For example, fifth cantilevered animal bed 1900 may be constructed identically to the first cantilevered animal bed 100 except with a substantially rigid panel formed, for example, from wood, metal or a suitable plastic, disposed between the textile layers of the spanning section 1902, with or without additional padding.

FIGS. 19A and 19B show how the fifth cantilevered animal bed 1900 can be disposed atop the narrower flat-topped furniture crest 1868N (FIG. 19A) or the wider furniture crest 1868W (FIG. 19B).

Reference is now made to FIG. 22, which shows a sixth non-limiting illustrative embodiment of a cantilevered animal bed, indicated generally at reference 2200, in cross-section. The cantilevered animal bed 2200 is comprises a textile envelope 2216 having a central stitch line 2272 whereby the cantilevered animal bed 2200 is formed as a conformable lemniscate of Bernoulli (e.g. generally a “FIG. 8” shape). The leaves of the lemniscate of Bernoulli form support sleeves 2218 in which the bodies 2205 of the cantilever supports 2204 are disposed. As before, the bodies 2205 of the cantilever supports 2204 may be, for example, cylinders of closed cell polyethylene (PE) foam of the type used to make so-called “pool noodles”. The spanning section 2202 is formed by a portion of the lemniscate of Bernoulli extending between the cantilever supports 2204, which extend substantially parallel to one another along opposed first sides 2206 of the spanning section 2202. The cantilever supports 2204 form load-bearing platforms 2208 extending beyond the spanning section 2202, and are hingedly coupled to the spanning section 2202 by an inherent living hinge formed by the textile envelope 2216.

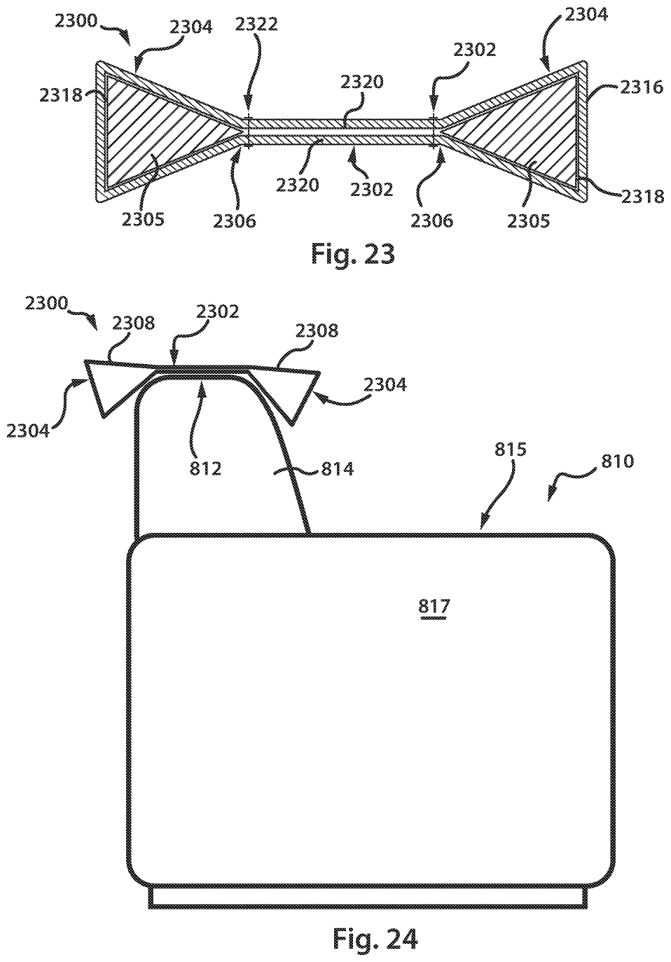

Reference is now made to FIGS. 23 and 24, which show a seventh non-limiting illustrative embodiment of a cantilevered animal bed, indicated generally by reference 2300, according to an aspect of the present disclosure. The seventh cantilevered animal bed 2300 shown in FIGS. 23 and 24 is similar to the first cantilevered animal bed 100 shown in FIGS. 1 to 10, with like reference numerals denoting like features, but with the prefix “23” instead of “1”. The third cantilevered animal bed 2300 differs from the first cantilevered animal bed 100 in that the bodies 2305 of the cantilever supports 2304 are triangular prisms rather than cylinders.

FIG. 24 shows the cantilevered animal bed 2300 on the hard-topped couch 810 from FIG. 8. The back 814 of the hard-topped couch 810 is disposed between the cantilever supports 2304, which rest against either side of the back 814 of the hard-topped couch 810. Since the top 812 of the back 814 of the hard-topped couch 810 is a hard, planar surface, the spanning section 2302 simply lays flat, and the cantilever supports 2304 extend horizontally beyond the vertical support provided by the back 814 of the hard-topped couch 810. The cantilever supports 2304 are braced against respective sides of the back 814 of the hard-topped couch 810 so that each cantilever support 2304 forms a support platform 2308 extending outwardly beyond the top 812 of the back 814 of the hard-topped couch 810.

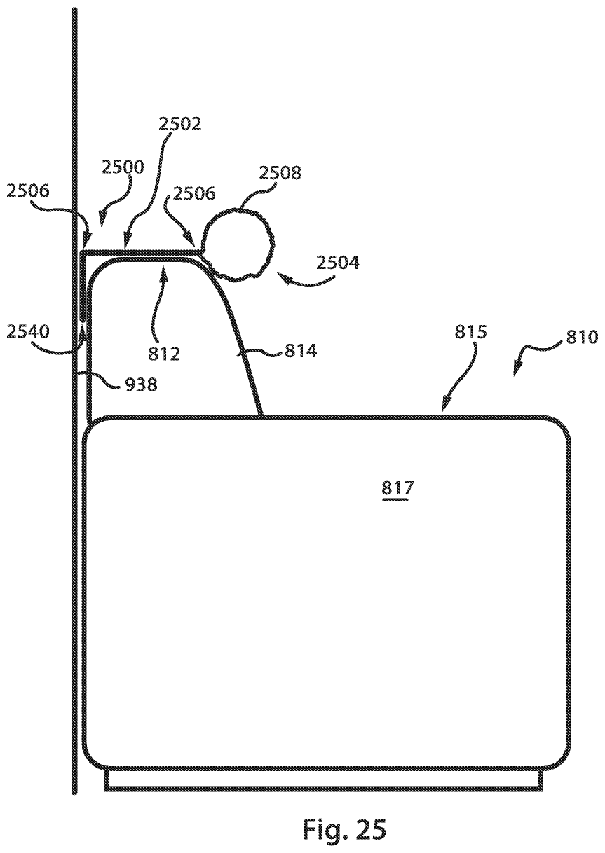

Reference is now made to FIG. 25, which shows an eighth non-limiting illustrative embodiment of a cantilevered animal bed, indicated generally at reference 2500, atop the back of the hard-topped couch 810. The eighth cantilevered animal bed 2500 is similar to the fifth cantilever animal bed 1900, but includes only a single cantilever support and is provided with an anchor in place of the second cantilever support. Thus, the eighth cantilevered animal bed 2500 comprises a spanning section 2502 and a cantilever support 2504 extending along one of a pair of opposed first sides 2506 of the spanning section 2502. The cantilever support 2504 is hingedly coupled to the spanning section 2502 at the one of the pair of opposed first sides 2506 of the spanning section 2502 along which the cantilever support 2504 extends. As in other embodiments, the cantilever support 2504 is adapted to form a load-bearing platform 2508 extending beyond the spanning section 2502. An anchor 2540 depends from the spanning section 2502. In the illustrated embodiment, the anchor 2540 depends from the other of the pair of opposed first sides 2506 of the spanning section; that is; the side 2506 opposite from the side 2506 along which the cantilever support 2504 extends. In the illustrated embodiment, the anchor 2540 comprises at least one substantially rigid, planar element. In some embodiments, a single rigid planar element may extend along substantially the entire length of the side 2506 opposite from the side 2506 along which the cantilever in support 2504 extends. In other embodiments, a plurality of spaced-apart substantially rigid planar elements may be provided. Other types of anchor are also contemplated. Also in the illustrated embodiment, the spanning section 2502 is substantially rigid; in other embodiments the spanning section may be flexible or conforming.

In FIG. 25, the cantilevered animal bed 2300 rests on the top 812 of the back 814 of the hard-topped couch 810. The anchor 2540 is trapped between the wall 938 and one side of the back 814 of the hard-topped couch 810 the hard-topped couch 810, thereby anchoring the cantilevered animal bed 2500 so that the spanning section 2502 rests on the top 812 of the back 814 of the hard-topped couch 810. The cantilever support 2504 rests against the side of the back 814 of the hard-topped couch 810 opposite the wall 938, and the cantilever support 2504 extends horizontally beyond the vertical support provided by the back 814 of the hard-topped couch 810. The cantilever support 2504 is braced against the side of the back 814 of the hard-topped couch 810 so that the cantilever support 2504 forms a support platform 2508 extending outwardly beyond the top 812 of the back 814 of the hard-topped couch 810.

In alternate embodiments, rather than substantially rigid, planar element(s) the anchor may comprise, for example, one or more elements formed from closed cell polyethylene (PE) foam of the type used to make so-called “pool noodles”, or a similar material, and shaped to be trapped between a wall and the back of a couch.

In the Figures, in some instances thickness and distances are exaggerated, and some separations between components are shown, for ease of illustration. In general, the drawings are provided for purposes of illustrating principles of construction of cantilevered animal beds according to the present disclosure, and are not necessarily to scale.

Several illustrative embodiments have been described by way of example. It will be apparent to persons skilled in the art that a number of variations and modifications can be made without departing from the scope of the claims.

### LISTING OF REFERENCE NUMERALS

The following list of reference numerals is provided for convenience only, and without limitation of any kind, express or implied:
100 First cantilever bed (generally)
102 Spanning section of first cantilever bed
104 Cantilever supports of first cantilever bed
105 Bodies of cantilever supports of first cantilever bed
106 Opposed first sides of spanning section of first cantilever bed
108 Load-bearing platforms of first cantilever bed
110 Sofa-style couch
112 Top of back of sofa-style couch
114 Back of sofa-style couch
115 Top of armrest of sofa-style couch
116 Textile envelope of first cantilever bed
117 Armrest of sofa-style couch
118 Support sleeves of first cantilever bed
120 Textile layers of spanning section first cantilever bed
122 Line of support stitching of first cantilever bed
124 Opposed second sides of spanning section of first cantilever bed
132 Silicone dots
710 Soft-topped cushion couch
712 Top of back of soft-topped cushion couch
714 Back of soft-topped cushion couch
734 Back cushion of soft-topped cushion couch
736 Top of back cushion
810 Hard-topped couch
812 Top of back of hard-topped couch
814 Back of hard-topped couch
815 Top of armrest of hard-topped couch
817 Armrest of hard-topped couch
938 Wall
1040 Cat (“Pepper”)
1100 Second cantilever bed (generally)
1102 Spanning section of second cantilever bed
1104 Cantilever supports of second cantilever bed
1105 Bodies of cantilever supports of second cantilever bed
1106 Opposed first sides of spanning section of second cantilever bed
1108 Load-bearing platforms of second cantilever bed
1116 Textile envelope of second cantilever bed
1118 Support sleeves of second cantilever bed
1120 Textile layers of spanning section of second cantilever bed
1122 Line of support stitching of second cantilever bed
1124 Opposed second sides of spanning section of second cantilever bed
1126 Comfort bolsters of second cantilever bed
1128 Pillow sleeves of second cantilever bed
1129 Pillow stitching
1130 Padding in comfort bolsters of second cantilever bed
1132 Silicone dots
1500 Third cantilever bed (generally)
1502 Spanning section of third cantilever bed
1504 Cantilever supports of third cantilever bed
1506 Opposed first sides of spanning section of third cantilever bed
1508 Load-bearing platforms of third cantilever bed
1524 Opposed second sides of spanning section of third cantilever bed
1550 Frictional anchoring surface of third cantilever bed
1552 Underside of spanning section of third cantilever bed
1554 Rubber sheet
1740 Cat (“Cooper”)
1800 Fourth cantilever bed (generally)
1802 Spanning section of fourth cantilever bed
1804 Cantilever supports of fourth cantilever bed
1806 Opposed first sides of spanning section of fourth cantilever bed
1808 Load-bearing platforms of fourth cantilever bed
1822 Living hinge of fourth cantilever bed
1860 Panel of spanning section of fourth cantilever bed
1862 Panel of cantilever support of fourth cantilever bed
1866 Bolsters of fourth cantilever bed
1868N Narrower flat-topped furniture crest
1868W Wider flat-topped furniture crest
1870N Narrower rounded furniture crest
1870W Wider rounded furniture crest
1900 Fifth cantilever bed (generally)
1902 Spanning section of fifth cantilever bed
1904 Cantilever supports of fifth cantilever bed
1906 Opposed first sides of spanning section of fifth cantilever bed
1908 Load-bearing platforms of fifth cantilever bed
2200 Sixth cantilever bed (generally)
2202 Spanning section of sixth cantilever bed
2204 Cantilever supports of sixth cantilever bed
2205 Bodies of cantilever supports of sixth cantilever bed
2206 Opposed first sides of spanning section of sixth cantilever bed
2208 Load-bearing platforms of sixth cantilever bed
2216 Textile envelope of sixth cantilever bed
2218 Support sleeves of sixth cantilever bed
2272 Central stitch line of sixth cantilever bed
2300 Seventh cantilever bed (generally)
2302 Spanning section of seventh cantilever bed
2304 Cantilever supports of seventh cantilever bed
2305 Bodies of cantilever supports of seventh cantilever bed
2306 Opposed first sides of spanning section of seventh cantilever bed
2308 Load-bearing platforms of seventh cantilever bed
2316 Textile envelope of seventh cantilever bed
2318 Support sleeves of seventh cantilever bed
2320 Textile layers of spanning section of seventh cantilever bed
2322 Line of support stitching of seventh cantilever bed
2500 Eighth cantilever bed (generally)
2502 Spanning section of eighth cantilever bed
2504 Cantilever support of eighth cantilever bed
2506 Opposed first sides of spanning section of eighth cantilever bed
2508 Load-bearing platform of eighth cantilever bed
2540 Anchor of eighth cantilever bed

What is claimed is:

1. A cantilevered animal bed, comprising:
a spanning section;
two opposed cantilever supports extending substantially parallel to one another along opposed first sides of the spanning section;
the cantilever supports being hingedly coupled to the spanning section;
the cantilever supports being adapted to form load-bearing platforms extending beyond the spanning section.

2. A combination, comprising:
the cantilevered animal bed of claim 1; and
a piece of cushioned furniture having at least one furniture crest, wherein each such furniture crest is an elongate region of local maximum elevation on the piece of cushioned furniture;
wherein, when the spanning section is placed atop one of the at least one furniture crest with the cantilever supports extending substantially parallel to a longitudinal extent of the one of the at least one furniture crest:
the cantilevered animal bed conforms to the one of the at least one furniture crest at least by hinged movement of the cantilever supports relative to the spanning section, whereby the one of the at least one furniture crest is disposed between the cantilever supports; and
the cantilever supports rest against the one of the at least one furniture crest.

3. The cantilevered animal bed of claim 1, wherein the cantilever supports are support bolsters.

4. The cantilevered animal bed of claim 1, further comprising comfort bolsters extending along opposed second sides of the spanning section.

5. The cantilevered animal bed of claim 1, wherein the spanning section is conformable to an underlying surface.

6. The cantilevered animal bed of claim 5, wherein the spanning section comprises a flexible conforming textile.

7. The cantilevered animal bed of claim 1, wherein the spanning section is substantially rigid.

8. The cantilevered animal bed of claim 7, wherein the cantilever supports are substantially rigid.

9. The cantilevered animal bed of claim 1, wherein bodies of the cantilever supports are substantially cylindrical.

10. The cantilevered animal bed of claim 1, wherein:
the cantilevered animal bed is formed as a conformable lemniscate of Bernoulli; and
the cantilever supports are disposed within leaves of the lemniscate of Bernoulli;
whereby the spanning section is formed by a portion of the lemniscate of Bernoulli extending between the cantilever supports.

11. The cantilevered animal bed of claim 1, wherein a frictional anchoring surface is disposed on at least one of:
an underside of the spanning section; or
undersides of the cantilever supports.

12. The cantilevered animal bed of claim 11, wherein the frictional anchoring surface is releasable from and remountable to the cantilevered animal bed.

13. The cantilevered animal bed of claim 1, wherein the cantilever supports are hingedly coupled to the spanning section by living hinges.

14. The cantilevered animal bed of claim 1, wherein the cantilever supports are substantially rigid.

15. A cantilevered animal bed, comprising:
a spanning section;
a cantilever support extending along one of a pair of opposed first sides of the spanning section;
the cantilever support being hingedly coupled to the spanning section;
the cantilever support being adapted to form a load-bearing platform extending beyond the spanning section; and
an anchor depending from the spanning section.

16. The cantilevered animal bed of claim 15, wherein the anchor comprises at least one substantially rigid, planar element.

17. The cantilevered animal bed of claim 15, wherein the spanning section is substantially rigid.

18. The cantilevered animal bed of claim 15, wherein the anchor depends from the other of the pair of opposed first sides of the spanning section.
